(19) United States
(12) Patent Application Publication
(10) Pub. No.: US 2004/0025622 A1
(43) Pub. Date: Feb. 12, 2004

(54) Pedal system for a motor vehicle comprising a displacement sensor

(76) Inventors: Konrad Slanec, St. Julians (MT); Gilbert Sammut, San Gwann (MT); Gregory Joslin, Birkirkara (MT); Uwe Neumann-Henneberg, Sliema (MT)

Correspondence Address: JACOBSON HOLMAN PLLC, 400 SEVENTH STREET N.W., SUITE 600, WASHINGTON, DC, 20004, US

(21) Appl. No.: 10/169,089

(22) PCT Filed: Dec. 1, 2000
(86) PCT No.: PCT/EP00/12104

(30) Foreign Application Priority Data
Dec. 3, 1999 (DE) 199 58 241.6

(51) Int. Cl. G05G 1/14

(52) U.S. Cl. 74/512

(57) ABSTRACT

The invention relates to a pedal system for a motor vehicle comprising a displacement sensor. Said sensor is used for determining the angular position of a foot pedal (1) and is provided as an inductive sensor which comprises a stationary coil part (3) and a metal part (4) that is displaced with the foot pedal (1). The distance of the metal part (4) from the coil part (3) alters the electric relationships from which corresponding measured values can be derived. This results in reducing the production complexity of the pedal system and in improving the functional reliability of the sensor.

The invention relates to a pedal arrangement for motor vehicles with at least one distance sensor.

It is customary to determine in coarse steps different pedal positions by means of end switches.

Furthermore, it is known to design the sensor as a rotary potentiometer, which detects continuously the angular position of the foot lever and whose rotatable parts are with a swivel axis of the pedal and in abradant connection with a stationary sensor element. The determined sensor values can also serve to improve the control of the drive and braking systems of the automobile. Such a sensor is subject to external disturbing influences, in particular extraneous metal particles and high wear, a state that results in the falsification of the output signals.

The invention is based on the problem of providing an interference insusceptible device of high sensitivity at low manufacturing cost.

The invention solves this problem in accordance with claim 1. The sensor, which works without contact, needs only an electrically active part that can be installed stationarily and independently of the structural parts of the pedal and the pedal suspension in the pedal space and can be connected electrically. The metal part, connected to the foot pedal, forms together with it a component and thus does not require any additional assembly labor. Since it is disposed outside the axis of the pedal, the installation of the foot lever is not impeded.

One special advantage of the sensor lies in its insensitivity to contamination and in its functionality, which is almost unlimited in time. In contrast, for example, to a magnetically acting Hall sensor, in the case of inductive sensors, working with high frequency alternating fields, no ice particles, which would severely change the sensor characteristics, are pulled into the sensor space.

Advantageous further developments of the invention follow from the features, characterized in claims 2 to 11.

The metal part, according to claim 2, can be made, for example, of a magnetically interacting material, which is better detectable as compared to a magnetically neutral material.

The device, according to claim 3, can be realized economically by means of assembly technology. The sensor parts detect directly the operating element, actuated directly by the foot of the driver. Thus, the actuating behavior can be directly and correctly sensed and evaluated.

The foot lever, which is, for example, ferromagnetic and is disclosed in claim 4, can be designed in such a manner that the metal part is designed inexpensively as a special one-piece casting of a lever area.

The foot lever, according to claim 5, improves the electromagnetic sensitivity of the sensor, whereby in particular the position and shape of the metal part can be adapted optimally to the sensor properties.

The foot lever, which can be produced, for example, by means of casting technology and which is disclosed in claim 6, can be adapted with high security against fracture especially well to the position and functional shape of the metal part, which can be fixed shape-lockingly in the pedal body, for example, by means of partial injection molding.

Owing to the contour, according to claim 7, the output signal of the sensor can be at least approximately linearized over a wide range of adjustment as a function of the pedal position so that the sensor sensitivity remains approximately the same over the entire range. Such a linearization, targeted by means of a compatibilized contour, would not be obtainable, for example, by means of a simple electric control. The contour can run, for example, approximately linearly and be coordinated in its orientation in relation to the electromagnetic properties of the sensor. For example, when the installation properties are different, it can be advantageous if the metal part is curved in the shape of a spiral. Owing to the arrangement of the sensor on the upper side opposite the operating element of the foot lever, the risk of contamination by means of, for example, contaminated footwear, is reduced in the sensor region.

The converter, according to claim 8, can be connected directly to the coil element at a short distance via short lines. Without interconnected contact parts and with less risk of failure, a high transfer guarantee is reached.

Owing to the carrier element, according to claim 9, a fixed allocation and accurate electrical tuning between the coil element and the converter is possible.

The double coil, according to claims 10 and 11, increases the redundancy of the sensor system in that even in the event of a fault at a coil the functionality is maintained. Owing to the continuous comparison of the measured values of both parts of the coil, faults in one sensor can be quickly detected. The reverse motion of both metal parts means that they approach the coil elements or move away from them. The result is a change in a summation or differential signal that is especially clear and easy to evaluate.

One embodiment of the invention is depicted in the drawings and is explained in detail below.

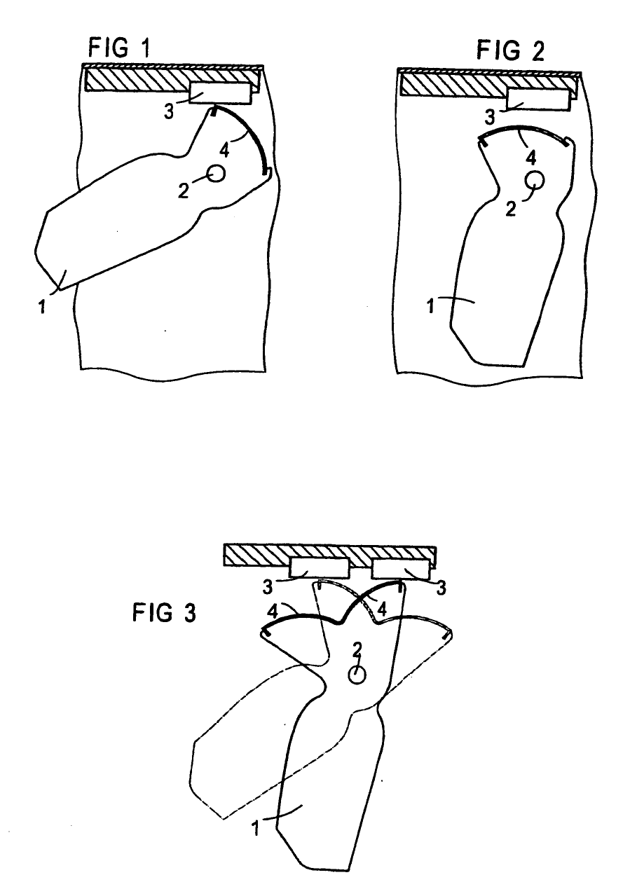

FIG. 1 is a schematic drawing of a partial side view of a pedal arrangement of an automobile in a starting position.

FIG. 2 depicts the parts, according to FIG. 1, in another functional position.

FIG. 3 is a side view of a modified pedal arrangement.

According to FIG. 1, a foot lever 1 is mounted in a pedal space of an automobile so as to pivot about a pedal axis 2. Above the foot lever 1 there is a stationarily mounted coil element 3, which induces an electromagnetic alternating field aimed at the foot lever 1. Fastened to the foot lever 1, which is made, for example, of glass fiber reinforced plastic, there is a metal part 4, which is made of ferromagnetic material and which together with the coil element forms an inductive sensor and whose distance to the coil changes as a function of the tilt position of the foot lever 1. This brings about a corresponding change in the inductive resistance of the coil element 3, a factor that results in a corresponding change in the measurable lost power of the coil element 3. The metal part 4, which is made of bent sheet metal, exhibits a convex cam-like curvature, whose contour is shaped in such a manner that the output signals of the sensor vary approximately in proportion to the angular position of the foot lever 1.

The metal part exhibits a flectional contour, which is easy to produce, and can be connected to the foot pedal with little effort by inserting into a casting mold for the foot lever. Therefore, this part of the sensor incurs almost no additional cost when subsequently installed into the pedal space. The coil element 3 can be installed into the pedal space independently of the assembly of the foot lever without any mutual hindrance.

In the illustrated starting position, one end of the metal part is closely adjacent to the coil element and has a correspondingly strong impact on its electromagnetic alternating field.

According to FIG. 2, the foot lever is swivelled into a functional position, in which the distance to the coil element 3 is significantly increased. The inductive resistance of the coil element has changed correspondingly. In a directly coupled converter (not illustrated) the sensor values can be converted into output signals and processed in an electronic unit.

According to FIG. 3, the sensor exhibits two adjacent coil elements 3, opposite which at the foot lever 1 there are two metal parts, which slope in opposite directions and are designed like toggle levers. The two metal parts are connected together here as one piece in a common central area to end segments that face each other so as to form a butterfly-like sensor element, a feature that reduces the manufacturing costs. The metal parts are designed in such a manner offset in relation to the pedal axis 2 that they approach alternatingly the respective coil element 3 or move away from said element. This action induces an especially strong change in the differential signal between the two coil elements 3.

In the starting position, which is indicated with a dashed-dotted line, one of the metal parts 4 has moved close to one of the coil elements 3, while the other metal part 4 is located in the position that is the furthest away from the coil element 3. In the end position of the foot lever 1 that is illustrated with a continuous solid line, the distance from the metal parts to their coil elements 3 has reversed itself.

1. Pedal arrangement for motor vehicles with a foot lever (1) and a sensor that senses the pedal travel,
characterized in
that the sensor is designed as an inductive distance sensor, which comprises a metal part (4) and a coil element (3), aimed at said metal part, and that the metal part (4) and the coil element (3) can be moved in relation to each other as a function of the pedal position.

2. Pedal arrangement, as claimed in claim 1,
characterized in
that the metal part (4) is made of magnetically and/or electrically interacting material.

3. Pedal arrangement, as claimed in claim 1 or 2,
characterized in
the coil element (3) is fastened to a stationary part of the pedal space and that the metal part (4) is coupled kinematically to the adjustable foot lever (1).

4. Pedal arrangement, as claimed in claim 1 or 2,
characterized in
that the metal part (4) is connected as one piece to the metal foot lever (1).

5. Pedal arrangement, as claimed in claim 3 or 4,
characterized in
that the metal part (4) is designed as a separate sensor element, which is mounted on a carrier of the foot lever (1), said carrier being not electromagnetically neutral.

6. Pedal arrangement, as claimed in claim 5,
characterized in
that the electromagnetically neutral foot lever (1) is made of glass-fiber reinforced plastic.

7. Pedal arrangement, as claimed in claim 4, 5 or 6,
characterized in
that the metal part (4) is disposed on a side of the pedal axis (2), which is opposite the operating area of the foot lever (1), between said side and the coil element (3), and
that a side of the metal part (4) that faces the coil element (3) exhibits a cam-like contour which points in the direction of the coil element (3) and which runs eccentrically in relation to a pedal axis (2) of the foot lever (1).

8. Pedal arrangement, as claimed in any one of the preceding claims,
characterized in
that the electric measurement values of the coil element (3) can be converted into output signals, which depend on the pedal position, by means of an electronic converter.

9. Pedal arrangement, as claimed in claim 8,
characterized in
that the coil element (3) and the converter are fastened to a joint carrier part.

10. Pedal arrangement, as claimed in any one of the preceding claims,
characterized in
that two coil elements (3) and two metal parts (4), which act in opposite directions, are provided for one of the coils respectively.

11. Pedal arrangement, as claimed in claim 10,
characterized in
that the stationary coils are adjacent to each other and that the two metal parts (4), which can be tilted about the pedal axis (2), are disposed in the manner of a butterfly between the pedal axis (2) and the coil elements (3).
